(19) United States
(12) Patent Application Publication
(10) Pub. No.: US 2025/0310822 A1
(43) Pub. Date: Oct. 2, 2025

(54) BURST ARRIVAL TIME REPORTING ENHANCEMENTS FOR XR

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US); Hyun Yong LEE, San Diego, CA (US)

(21) Appl. No.: 19/075,594

(22) Filed: Mar. 10, 2025

Related U.S. Application Data
(60) Provisional application No. 63/572,842, filed on Apr. 1, 2024.

(51) Int. Cl. H04W 28/02; H04L 1/1607; H04W 76/20

(52) U.S. Cl. CPC H04W 28/0268; H04L 1/1642; H04W 76/20

(57) ABSTRACT

Apparatus, methods, and computer program products for wireless communication are provided. An example method may include receiving, from a user equipment (UE), a burst arrival time (BAT) report including BAT information associated with at least one quality of service (QOS) flow associated with an extended reality (XR) session. The example method may further include transmitting, for a second network node, the BAT information associated with the at least one QoS flow.

### CROSS REFERENCE TO RELATED APPLICATION(S)

This application claims the benefit of and priority to U.S. Provisional Application Ser. No. 63/572,842, entitled “BURST ARRIVAL TIME REPORTING ENHANCEMENTS FOR XR” and filed on Apr. 1, 2024, which is expressly incorporated by reference herein in its entirety.

### TECHNICAL FIELD

The present disclosure relates generally to communication systems, and more particularly, to wireless communication systems burst arrival time reporting.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network node are provided. The apparatus may include at least one memory and at least one processor coupled to the at least one memory. Based at least in part on information stored in the at least one memory, the at least one processor, individually or in any combination, is configured to receive, from a user equipment (UE), a burst arrival time (BAT) report including BAT information associated with at least one quality of service (QOS) flow associated with an extended reality (XR) session. Based at least in part on information stored in the at least one memory, the at least one processor, individually or in any combination, is configured to transmit, for a second network node, the BAT information associated with the at least one QoS flow.

In another aspect of the disclosure, a method, a computer-readable medium, and an apparatus at a first network node are provided. The apparatus may include at least one memory and at least one processor coupled to the at least one memory. Based at least in part on information stored in the at least one memory, the at least one processor, individually or in any combination, is configured to receive, from a second network node, burst arrival time (BAT) information associated with at least one quality of service (QOS) flow associated with an extended reality (XR) session of a user equipment (UE). Based at least in part on information stored in the at least one memory, the at least one processor, individually or in any combination, is configured to configure, for the UE based on the BAT information, a secondary cell group (SCG) configuration, a master cell group (MCG) configuration, a discontinuous reception (DRX) configuration, or a configured grant (CG).

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating example aspects of XR traffic, in accordance with various aspects of the present disclosure.

FIG. 4B is a diagram illustrating an example of a secondary cell group (SCG) and a master cell group (MCG), in accordance with various aspects of the present disclosure.

FIG. 5 is a diagram illustrating an example of communications between a first network node, a second network node, and a user equipment (UE), in accordance with various aspects of the present disclosure.

FIG. 6 is a flowchart of a method of wireless communication, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for a network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Arrival times of extended reality (XR) traffic may vary. For example, XR traffic bursts may arrive and be available for transmission at a time that is earlier or later than a time at which a user equipment (UE) (or a base station) expects the XR traffic bursts. To support XR in dual connectivity (DC) scenarios, burst arrival time (BAT) reporting may be supported. Aspects provided herein may enable support of BAT reporting in XR DC.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

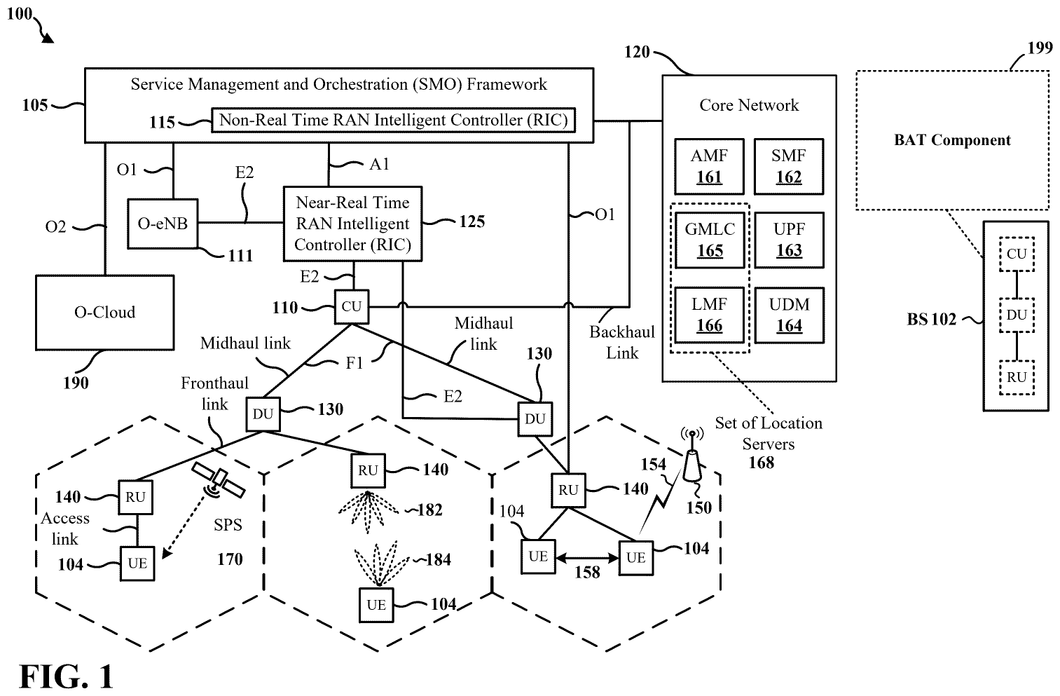

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the base station 102 may include a BAT component 199. In some aspects, the BAT component 199 may be configured to receive, from a user equipment (UE), a burst arrival time (BAT) report including BAT information associated with at least one quality of service (QOS) flow associated with an extended reality (XR) session. In some aspects, the BAT component 199 may be configured to transmit, for a second network node, the BAT information associated with the at least one QoS flow. In some aspects, the BAT component 199 may be configured to receive, from a second network node, burst arrival time (BAT) information associated with at least one quality of service (QOS) flow associated with an extended reality (XR) session of a user equipment (UE). In some aspects, the BAT component 199 may be configured to configure, for the UE based on the BAT information, a secondary cell group (SCG) configuration, a master cell group (MCG) configuration, a discontinuous reception (DRX) configuration, or a configured grant (CG).

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

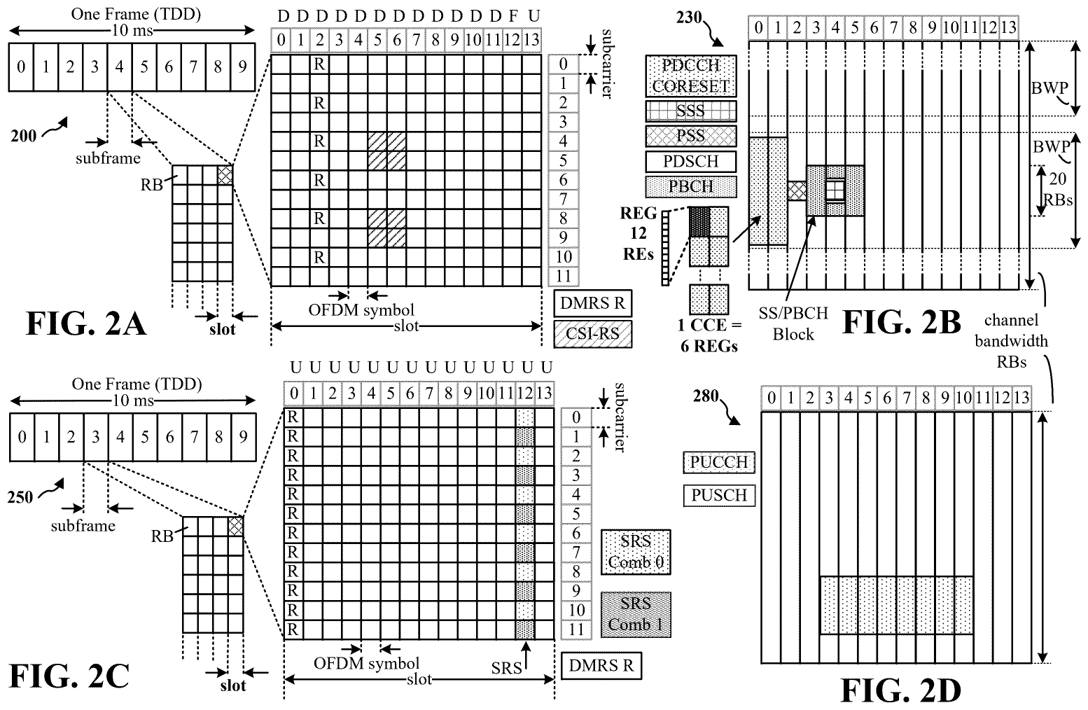

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

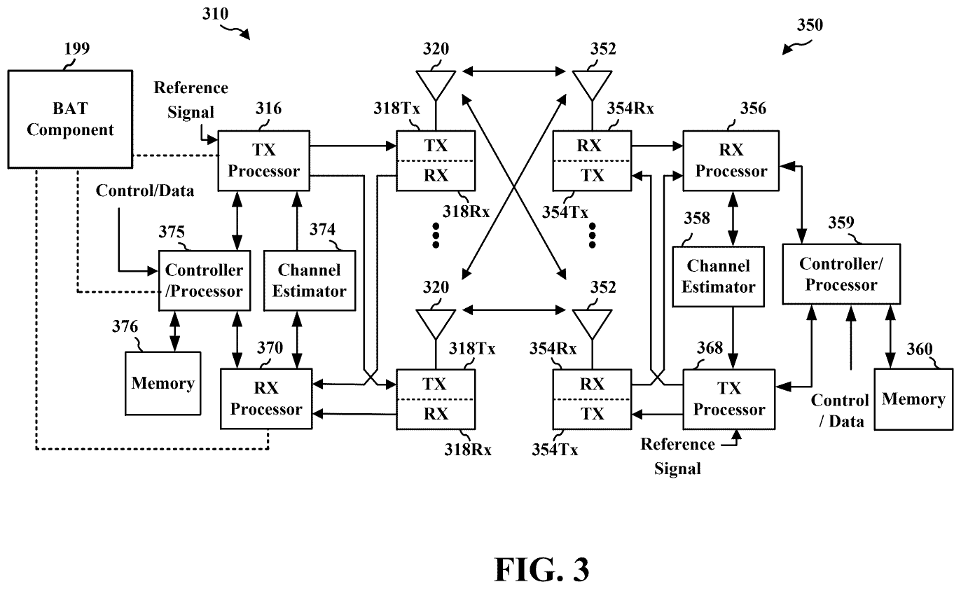

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with BAT component 199 of FIG. 1.

Wireless communication system may support various types of wireless communication. Some wireless communication may include XR traffic. In some aspects, XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

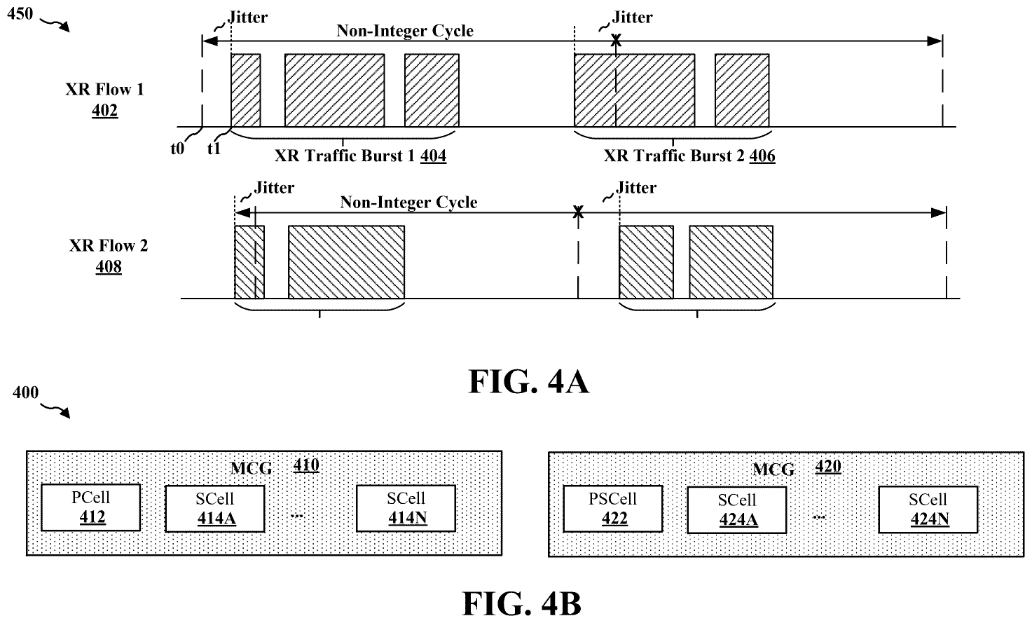

XR traffic may arrive in periodic traffic bursts (“XR traffic bursts”). FIG. 4A illustrates an example diagram 450 showing a first XR flow 402 that includes a first XR traffic burst 404 and a second XR traffic burst 406. An XR traffic burst may vary in a number of packets per burst and/or a size of each packet in the burst. XR traffic bursts may arrive at non-integer periods (i.e., in a non-integer cycle). The periods may be different than an integer number of symbols, slots, etc. Arrival times of XR traffic may vary. For example, XR traffic bursts may arrive and be available for transmission at a time that is earlier or later than a time at which a UE (or a base station) expects the XR traffic bursts. The variability of the packet arrival relative to the period may be referred to as “jitter.” XR traffic may include multiple flows that arrive at a UE (or a network node such as a base station) concurrently with one another (or within a threshold period of time). As an example, the diagram 450 includes a second XR flow 408. The second XR flow 408 may have different characteristics than the first XR flow 402. For instance, the second XR flow 408 may have XR traffic bursts with different numbers of packets, different sizes of packets, etc. than the first XR flow 402. In an example, the first XR flow may include video data and the second XR flow may include audio data for the video data. In another example, the first XR flow may include intra-coded picture frames (I-frames) that include complete images and the second XR flow may include predicted picture frames (P-frames) that include changes from a previous image.

XR traffic may have an associated packet delay budget (PDB). If a packet does not arrive within the PDB, a UE (or a base station) may discard the packet. In an example, if a packet corresponding to a video frame of a video does not arrive at a UE within a PDB, the UE may discard the packet, as the video has advanced beyond the frame. XR traffic may be characterized by relatively high data rates and low latency. The latency in XR traffic may affect the user experience. For instance, XR traffic may have applications in cMBB and URLLC services.

In some wireless communication systems, a UE may report the average value of the arrival time of the first packet of the data burst for a QoS flow. The Burst Arrival Time (BAT) may be reported in the radio resource control (RRC) UE Assistance Information message, as an example. The BAT may be reported, e.g., (1) as reference time; or (2) as referenceSFN-AndSlot (reference system frame number and slot). As an example, when the BAT is reported as reference time, the indicated time may be in 10 ns units from an origin or reference time. For example, an indicated time may be: refDays*86400*1000*100000+refSeconds*1000*100000+refMilliSeconds*100000+refTenNanoSeconds. The refDays field specifies the sequential number of days (with day count starting at 0) from 00:00:00 on Gregorian calendar date 6 Jan. 1980 (e.g., using the start of GPS time as an origin or reference time). As an example, when the BAT is reported using a SFN and/or slot as a reference time (e.g., as referenceSFN-AndSlot), the BAT may refer to the UL timing of the closest system frame number (SFN) and slot of the primary cell (PCell) with the indicated number. To support XR in Dual Connectivity (NR-DC) scenarios, BAT reporting may be supported. Aspects provided herein may enable support of BAT reporting in XR DC.

FIG. 4B is a diagram 400 illustrating an example of a secondary cell group (SCG) and a master cell group (MCG), in accordance with various aspects of the present disclosure. As illustrated in FIG. 4B, the MCG 410 may include a PCell 412 and a set of SCells including a first SCell 414A, . . . and Nth SCell 414N. The SCG 420 may include a PSCell 422 and a set of SCells including a first SCell 424A, and any number of SCells up to an Nth SCell 424N.

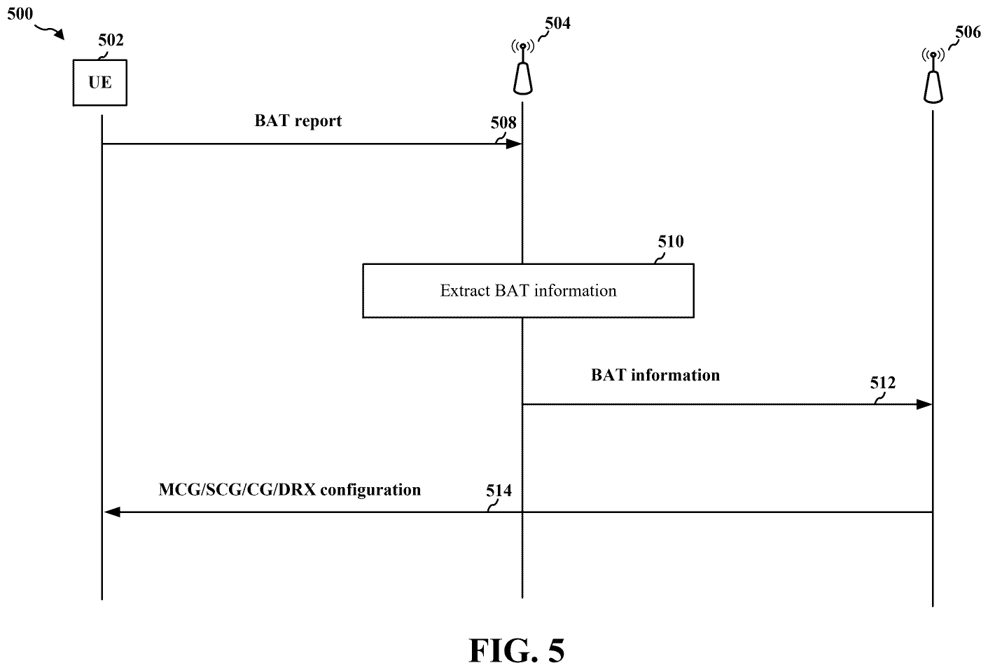

FIG. 5 is a diagram 500 illustrating an example of communications between a first network node 504, a second network node 506, and a UE 502, in accordance with various aspects of the present disclosure. As illustrated in FIG. 5, the UE 502 may transmit a BAT report 508 to the first network node 504. The first network node 504 may extract, at 510, BAT information from the BAT report and forward the BAT information 512 to the second network node 506. Based on the BAT information 512, the second network node may configure MCG, SCG, CG, or DRX configuration 514 for the UE 502. For example, a DRX configuration may configure the UE to monitor for PDCCH transmissions in a discontinuous manner, e.g., using a sleep and wake cycle. A DRX cycle includes a DRX OFF duration and a DRX On duration. During DRX OFF durations, the UE does not monitor for PDCCH, and during the DRX ON durations, the UE monitors for PDCCH transmissions from the network. When the UE is in an RRC connected state, the DRX may also be referred to as connected node DRX (C-DRX). DRX conserves battery power at the UE. In a non-DRX mode, the UE monitors for PDCCH in each subframe to check whether there is downlink data available. In some aspects, scheduling mechanisms such as semi-persistent scheduling (SPS) or a configured grant (CG) may be used to provide (e.g., grant or allocate) the UE with periodic resources for UL or DL communication that can be used without a dynamic grant of resources. For example, the network may provide one or more CGs of recurring resources for uplink/downlink transmissions in radio resource control (RRC) signaling to the UE. For some types of configured grants, the UE may use the allocated resources based on the RRC configuration and without activation or control signaling from the network. In other types of configured grants, the UE may further receive an indication that the configured grant is activated or enabled for the UE to use, e.g., in a medium access control-control element (MAC-CE) or downlink control information (DCI). The UE may then use the recurring resources of the configured grant for uplink transmissions, e.g., until the UE receives signaling from the network that the configured grant is deactivated. The SPS or CG scheduling may be configured to accommodate the periodic traffic, multiple flows, jitter, latency, and reliability for the wireless traffic and may improve capacity and/or latency for such wireless communication.

In some aspects, the first network node 504 may be the SN and the second network node 506 may be the MN. In some aspects, the first network node 504 may be the MN and the second network node 506 may be the SN.

As an example, aspects provided herein may address various different scenarios related to XR DC. In a first example DC scenario, if signaling radio bearer (SRB) 3 (a direct SRB between the SN and the UE) is not present, the SN may not know the burst arrival time (BAT), and is not able to configure the UE in the SCG accordingly (e.g. connected mode discontinuous reception (CDRX), configured grants). In another example DC scenario, if SRB 3 is present, the UE can report the BAT to the secondary node (SN), but the master node (MN) may not know the BAT, and is not able to configure the UE in the MCG based on the BAT. SRB 3 is a type of signaling bearer to support signaling over split bearers when the UE is connected in a DC mode. SRB 3 may carry RRC signaling between the UE and a secondary node (SN).

Based on aspects provided herein, when there is no SRB 3 configured, the MN may signal the BAT to the SN. As an example, upon reception of a BAT report from the UE, the MN may forward BAT information to the SN. The BAT information (e.g., 512) may be transmitted to the SN in various ways, e.g., (1) the BAT may be extracted (e.g., at 510) from the RRC UE Assistance Information message (e.g., 508) and transmitted to the SN, or (2) the whole RRC UE Assistance Information message (e.g., 508) may be transmitted (e.g., forwarded) to the SN as an octet string, and the SN may extract the BAT. An Xn Application Protocol message, such as an S-NODE ADDITION REQUEST message or an S-NODE MODIFICATION REQUEST message may be used to carry the BAT information. If extracted by the MN, the BAT may be added to the S-NODE ADDITION REQUEST message or the S-NODE MODIFICATION REQUEST as an Xn-AP information element (IE) Burst Arrival Time. Examples are provided below:

```
S-NODE ADDITION REQUEST
  > PDU Session Resources To Be Added List
    >> PDU Session Resources To Be Added Item
      >>> PDU Session Resource Setup Info - MN/SN terminated
        >>>> QoS Flows To Be Setup List
          >>>>> QoS Flows To Be Setup Item
            >>>>> Burst Arrival Time
S-NODE MODIFICATION REQUEST
  > PDU Session Resources To Be Added List
    >> Same as ‘S-NODE ADDITION REQUEST’
  > PDU Session Resources To Be Modified List
    >> PDU Session Resources To Be Modified Item
      >>> PDU Session Resource Modification Info - MN/SN terminated
        >>>> DRBs To Be Setup List
          >>>> DRBs To Be Setup Item
            >>>>> QoS Flows Mapped to DRB List
              >>>>>> QoS Flows Mapped to DRB Item
                >>>>>>> Burst Arrival Time
        >>>> DRBs To Be Modified List
          >>>> DRBs To Be Modified Item
            >>>>> QoS Flows Mapped to DRB List
              >>>>>> QoS Flows Mapped to DRB Item
                >>>>>>> Burst Arrival Time
```

The IE PDU Session Resources To Be Added List may represent the PDU sessions that would be handled by the SN. The IE PDU Session Resources To Be Added Item may represent PDU session assigned to the SN, which may include PDU Session Resource Setup Info, which specifies whether the session is MN-terminated or SN-terminated. The IE QoS Flows To Be Setup List may include QoS flows that would be established within the PDU session. The IE QoS Flows To Be Setup Item may represent QoS flow(s) to be established for the session. The IE Burst Arrival Time, which indicates the expected arrival time of data bursts for the QoS flow, may be included as well.

The IE DRBs To Be Setup List may represent new DRBs that may be set up for the session. The IE DRBs To Be Setup Item may represent individual DRB(s) that will carry QoS flows. The IE QOS Flows Mapped to DRB List may represent QoS flows mapped to this DRB. The IE QOS Flows Mapped to DRB Item represents individual QoS flow(s) within the PRB. The IE DRBs To Be Modified List may represent DRBs that may be updated. The IE DRBs To Be Modified Item represents individual DRB(s) that may be updated.

Another example of IEs for reporting burst arrival time is provided below:

ReferenceTime-r16 ::= SEQUENCE {
refDays-r16 INTEGER (0..72999),
refSeconds-r16 INTEGER (0..86399),
refMilliSeconds-r16 INTEGER (0..999),
refTenNanoSeconds-r16 INTEGER (0..99999) }
burstArrivalTime-r18 CHOICE {
referenceTime ReferenceTime-r16,
referenceSFN-AndSlot ReferenceSFN-AndSlot-r18 }
ReferenceSFN-AndSlot-r18 ::=
SEQUENCE {
referenceSFN-r18 INTEGER (0..1023),
referenceSlot-r18 INTEGER (0..639) }

The IE ReferenceTime-r16 represents a precise timestamp that includes a number of days represented by refDays, number of seconds represented by refSeconds, number of milliseconds represented by refMilliSeconds, and number of ten nanoseconds represented by refTenNanoSeconds. The IE burstArrivalTime may indicate the burst arrival time either based on reference time or based on reference SFN and slot (which is represented by ReferenceSFN-AndSlot).

The IE burstArrivalTime that is based on either reference time or reference SFN and slot may be used for reporting BAT. If sent as an octet string, the RRC UE Assistance Information is added to the to the S-NODE ADDITION REQUEST message or the S-NODE MODIFICATION REQUEST as an Xn-AP IE “UE Assistance Information.” An example is provided below:

S-NODE ADDITION REQUEST
S-NODE MODIFICATION REQUEST
> UE Assistance Information

If burstArrivalTime is indicated as referenceSFN-AndSlot, it refers to the UL timing of the closest SFN and slot of the PCell with the indicated number. In asynchronous scenarios, the MN and the SN may not have the same timing. The SN may be aware of the difference between its timing and the MN's timing to adjust the BAT accordingly. Nodes can signal their offset between the International Atomic Time and their SFN0 start through the Xn-AP IE “SFN Offset” during Xn Setup and NG-RAN node configuration update procedures. If the MN did not signal its “SFN offset” to the SN during these procedures, the MN may include it along with the BAT. An IE SFN offset, which may contain time offset between an absolute time reference and the SFN0 start and calculated assuming that the SFN transmission started at the start reference, may be is added as an IE to the S-NODE ADDITION REQUEST message or the S-NODE MODIFICATION REQUEST. An example is provided below:

S-NODE ADDITION REQUEST
S-NODE MODIFICATION REQUEST
> SFN Offset

Based on aspects provided herein, when there is SRB 3 configured, the SN may signal the BAT to the MN. Upon reception of a BAT report from the UE, the SN can forward BAT information to the MN. The BAT information may be transmitted to the MN in two ways: (1) the BAT is extracted from the RRC UE Assistance Information message and transmitted to the MN, or (2) the whole RRC UE Assistance Information message is transmitted to the MN as an octet string, and the MN may extract the BAT.

To carry the BAT information, an Xn-AP message, such as the S-NODE MODIFICATION REQUIRED message, may be used. If extracted by the SN, the BAT is added to the S-NODE MODIFICATION REQUIRED message as an Xn-AP IE “Burst Arrival Time.” An example is provided below:

```
S-NODE MODIFICATION REQUIRED
  > PDU Session Resources To Be Modified List
    >> PDU Session Resources To Be Modified Item
      >>> PDU Session Resource Modification Info - MN terminated
(and SN terminated)
        >>>> DRBs To Be Setup List
          >>>> DRBs To Be Setup Item
            >>>>> QoS Flows Mapped to DRB List
              >>>>>> QoS Flows Mapped to DRB Item
                >>>>>>> Burst Arrival Time
        >>>> DRBs To Be Modified List
          >>>> DRBs To Be Modified Item
            >>>>> QoS Flows Mapped to DRB List
              >>>>>> QoS Flows Mapped to DRB Item
                >>>>>>> Burst Arrival Time
```

If sent as an octet string, the RRC UE Assistance Information is added to the S-NODE MODIFICATION REQUIRED message as an Xn-AP IE “UE assistance information.” An example is provided below:

S-NODE MODIFICATION REQUIRED
> UE Assistance Information

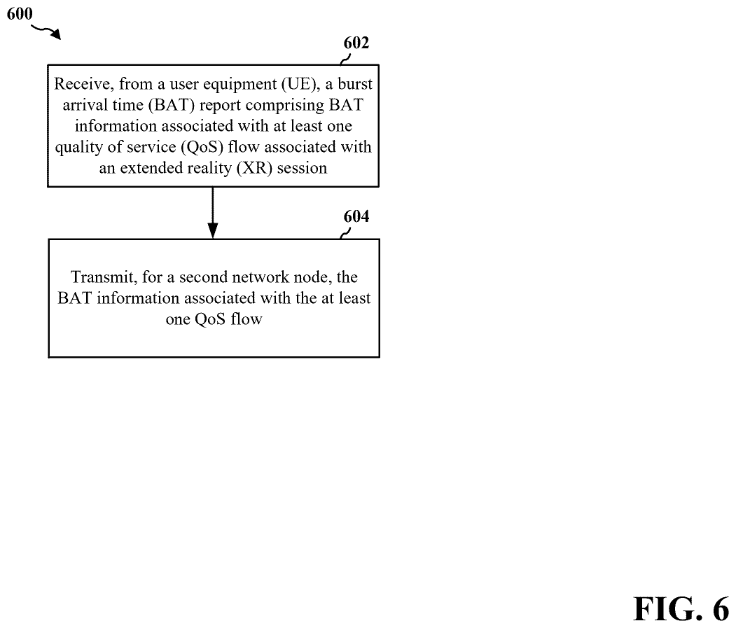

FIG. 6 is a flowchart 600 of a method of wireless communication. The method may be performed by a first network node (e.g., the base station 102, the first network node 504, the network entity 1060). Aspects provided herein may enable support of burst arrival time reporting in dual-connectivity scenarios, which improves efficiency of communication related to an extended reality session associated with a user equipment.

At 602, the first network node may receive, from a UE, a BAT report including BAT information associated with at least one QoS flow associated with an XR session. In some aspects, 602 may be performed by BAT component 199. As an example, the first network node 504 may receive, from a UE 502, a BAT report (e.g., 508) including BAT information associated with at least one QoS flow associated with an XR session.

At 604, the first network node may transmit, for a second network node, the BAT information associated with the at least one QoS flow. In some aspects, 604 may be performed by BAT component 199. As an example, the first network node 504 may transmit, for a second network node 506, the BAT information (e.g., 512) associated with the at least one QoS flow.

In some aspects, the first network node is a MN associated with the UE and the second network node is a SN associated with the UE, where a direct SRB between the SN and the UE is not present. In some aspects, the BAT report is included in radio resource control (RRC) UE assistance information, and where to transmit the BAT information, the first network node may: extract the BAT information from the RRC UE assistance information; and transmit, for the second network node, the BAT information. In some aspects, the BAT information is included in an SN addition request or an SN modification request as an information element representative of the BAT information. In some aspects, the BAT report is included in RRC UE assistance information, and where to transmit the BAT information, the first network node may forward the RRC UE assistance information to the second network node as an Octet string. In some aspects, the Octet string is included in an SN addition request or an SN modification request as an information element representative of the RRC UE assistance information. In some aspects, to transmit the BAT information, the first network node may. In some aspects, the SN addition request or the SN modification request further includes a system frame number (SFN) offset.

In some aspects, the second network node is a MN associated with the UE and the first network node is a SN associated with the UE, where a direct SRB between the SN and the UE is present. In some aspects, the BAT report is included in RRC UE assistance information, and where to transmit the BAT information, the first network node may extract the BAT information from the RRC UE assistance information; and transmit, for the second network node, the BAT information. In some aspects, the BAT information is included in an SN modification required message as an information element representative of the BAT information. In some aspects, the BAT report is included in RRC UE assistance information, and where to transmit the BAT information, the first network node may forward the RRC UE assistance information to the second network node as an Octet string. In some aspects, the Octet string is included in an SN modification required message as an information element representative of the RRC UE assistance information. In some aspects, to transmit the BAT information, the first network node may transmit the BAT information in an SN modification required message.

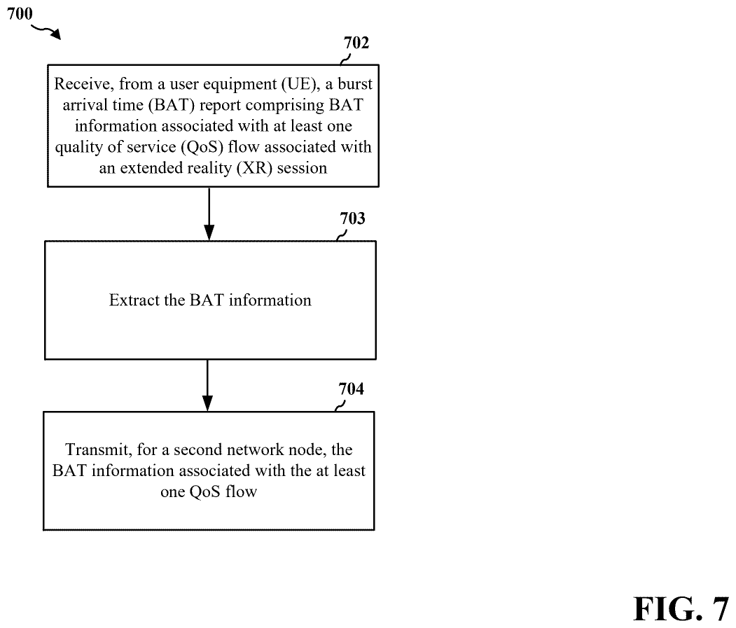

FIG. 7 is a flowchart 700 of a method of wireless communication. The method may be performed by a first network node (e.g., the base station 102, the first network node 504, the network entity 1060). Aspects provided herein may enable support of burst arrival time reporting in dual-connectivity scenarios, which improves efficiency of communication related to an extended reality session associated with a user equipment.

At 702, the first network node may receive, from a UE, a BAT report including BAT information associated with at least one QoS flow associated with an XR session. In some aspects, 702 may be performed by BAT component 199. As an example, the first network node 504 may receive, from a UE 502, a BAT report (e.g., 508) including BAT information associated with at least one QoS flow associated with an XR session.

At 704, the first network node may transmit, for a second network node, the BAT information associated with the at least one QoS flow. In some aspects, 704 may be performed by BAT component 199. As an example, the first network node 504 may transmit, for a second network node 506, the BAT information (e.g., 512) associated with the at least one QoS flow.

In some aspects, the first network node is a MN associated with the UE and the second network node is a SN associated with the UE, where a direct SRB between the SN and the UE is not present. In some aspects, the BAT report is included in radio resource control (RRC) UE assistance information, and where to transmit the BAT information, the first network node may: extract the BAT information (e.g., at 703, which corresponds to 510 in FIG. 5) from the RRC UE assistance information; and transmit, for the second network node, the BAT information. In some aspects, the BAT information is included in an SN addition request or an SN modification request as an information element representative of the BAT information. In some aspects, the BAT report is included in RRC UE assistance information, and where to transmit the BAT information, the first network node may forward the RRC UE assistance information to the second network node as an Octet string. In some aspects, the Octet string is included in an SN addition request or an SN modification request as an information element representative of the RRC UE assistance information. In some aspects, to transmit the BAT information, the first network node may. In some aspects, the SN addition request or the SN modification request further includes a system frame number (SFN) offset.

In some aspects, the second network node is a MN associated with the UE and the first network node is a SN associated with the UE, where a direct SRB between the SN and the UE is present. In some aspects, the BAT report is included in RRC UE assistance information, and where to transmit the BAT information, the first network node may extract the BAT information from the RRC UE assistance information; and transmit, for the second network node, the BAT information. In some aspects, the BAT information is included in an SN modification required message as an information element representative of the BAT information. In some aspects, the BAT report is included in RRC UE assistance information, and where to transmit the BAT information, the first network node may forward the RRC UE assistance information to the second network node as an Octet string. In some aspects, the Octet string is included in an SN modification required message as an information element representative of the RRC UE assistance information. In some aspects, to transmit the BAT information, the first network node may transmit the BAT information in an SN modification required message.

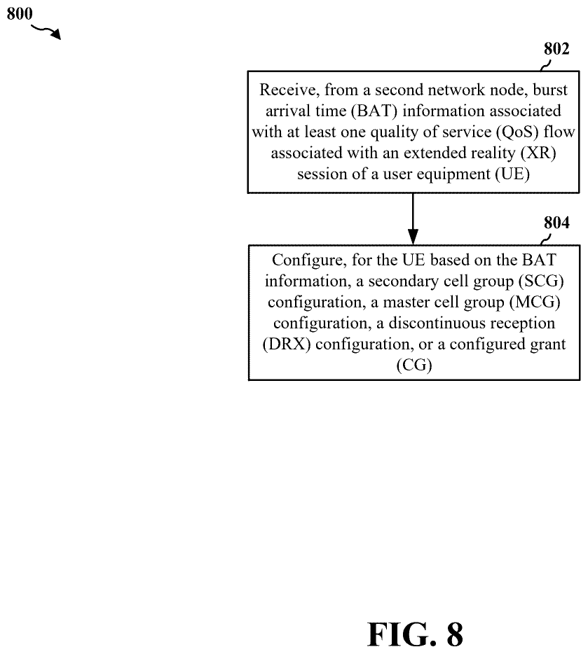

FIG. 8 is a flowchart 800 of a method of wireless communication. The method may be performed by a first network node (e.g., the base station 102, the network node 506, the network entity 1060). Aspects provided herein may enable support of burst arrival time reporting in dual-connectivity scenarios, which improves efficiency of communication related to an extended reality session associated with a user equipment.

At 802, the first network node may receive, from a second network node, BAT information associated with at least one QoS flow associated with an XR session of a UE. In some aspects, 802 may be performed by BAT component 199. As an example, the first network node (e.g., 504) may receive, from a second network node (e.g., 502), BAT information (e.g., 512) associated with at least one QoS flow associated with an XR session of a UE (e.g., 512).

At 804, the first network node may configure, for the UE based on the BAT information, a secondary cell group (SCG) configuration, a master cell group (MCG) configuration, a discontinuous reception (DRX) configuration, or a configured grant (CG). In some aspects, 804 may be performed by BAT component 199. As an example, the first network node may configure, for the UE (e.g., 502) based on the BAT information (e.g., 512), a secondary cell group (SCG) configuration, a master cell group (MCG) configuration, a discontinuous reception (DRX) configuration, or a configured grant (CG) (e.g., 514).

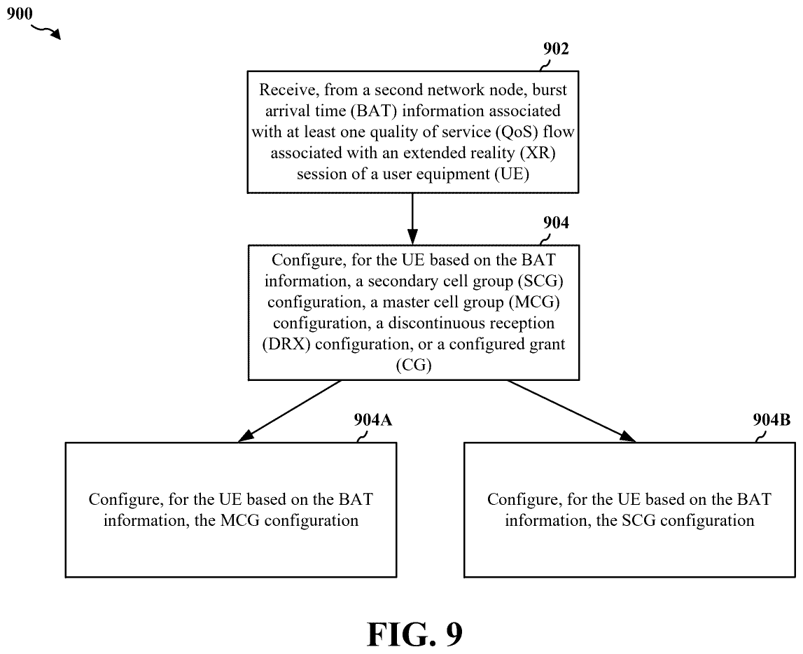

FIG. 9 is a flowchart 900 of a method of wireless communication. The method may be performed by a first network node (e.g., the base station 102, the network node 506, the network entity 1060). Aspects provided herein may enable support of burst arrival time reporting in dual-connectivity scenarios, which improves efficiency of communication related to an extended reality session associated with a user equipment.

At 902, the first network node may receive, from a second network node, BAT information associated with at least one QoS flow associated with an XR session of a UE. In some aspects, 902 may be performed by BAT component 199. As an example, the first network node (e.g., 504) may receive, from a second network node (e.g., 502), BAT information (e.g., 512) associated with at least one QoS flow associated with an XR session of a UE (e.g., 512).

At 904, the first network node may configure, for the UE based on the BAT information, a secondary cell group (SCG) configuration, a master cell group (MCG) configuration, a discontinuous reception (DRX) configuration, or a configured grant (CG). In some aspects, 904 may be performed by BAT component 199. As an example, the first network node may configure, for the UE (e.g., 502) based on the BAT information (e.g., 512), a secondary cell group (SCG) configuration, a master cell group (MCG) configuration, a discontinuous reception (DRX) configuration, or a configured grant (CG) (e.g., 514). In some aspects, at 904A, the first network node may configure the MCG configuration for the UE. In some aspects, at 904B, the first network node may configure the SCG configuration for the UE.

In some aspects, the first network node is a MN associated with the UE and the second network node is a SN associated with the UE, where a direct SRB between the SN and the UE is present. In some aspects, the first network node may configure, for the UE based on the BAT information, the MCG configuration. In some aspects, the second network node is a MN associated with the UE and the first network node is a SN associated with the UE, where a direct SRB between the SN and the UE is not present. In some aspects, the first network entity may configure, for the UE based on the BAT information, the SCG configuration. In some aspects, to receive the BAT information, the first network node may receive the BAT information in an SN modification required message.

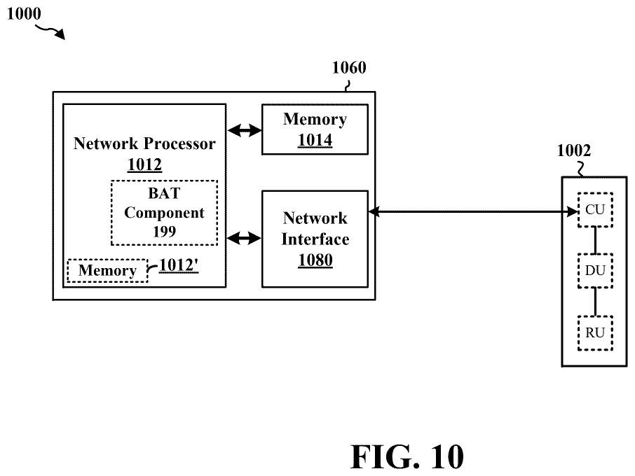

FIG. 10 is a diagram 1000 illustrating an example of a hardware implementation for a network entity 1060. In one example, the network entity 1060 may be within the core network 120. The network entity 1060 may include at least one network processor 1012. The network processor(s) 1012 may include on-chip memory 1012′. In some aspects, the network entity 1060 may further include additional memory modules 1014. The network entity 1060 communicates via the network interface 1080 directly (e.g., backhaul link) or indirectly (e.g., through a RIC) with the CU 1002. The on-chip memory 1012′ and the additional memory modules 1014 may each be considered a computer-readable medium/memory. Each computer-readable medium/memory may be non-transitory. The network processor(s) 1012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the BAT component 199 may be configured to receive, from a user equipment (UE), a burst arrival time (BAT) report including BAT information associated with at least one quality of service (QOS) flow associated with an extended reality (XR) session. In some aspects, the BAT component 199 may be configured to transmit, for a second network node, the BAT information associated with the at least one QoS flow. In some aspects, the BAT component 199 may be configured to receive, from a second network node, burst arrival time (BAT) information associated with at least one quality of service (QOS) flow associated with an extended reality (XR) session of a user equipment (UE). In some aspects, the BAT component 199 may be configured to configure, for the UE based on the BAT information, a secondary cell group (SCG) configuration, a master cell group (MCG) configuration, a discontinuous reception (DRX) configuration, or a configured grant (CG). The component 199 may be further configured to perform any of the aspects described in connection with any of the flowcharts in FIGS. 6-9 and/or performed in the communication flow of FIG. 5. The component 199 may be within the network processor(s) 1012. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1060 may include a variety of components configured for various functions. In some aspects, the network entity 1060 may include means for receiving, from a UE, a BAT report including BAT information associated with at least one QoS flow associated with an XR session. In some aspects, the network entity 1060 may include means for transmitting, for a second network node, the BAT information associated with the at least one QoS flow. In some aspects, the network entity 1060 may include means for extracting the BAT information from the RRC UE assistance information. In some aspects, the network entity 1060 may include means for transmitting, for the second network node, the BAT information. In some aspects, the network entity 1060 may include means for forwarding the RRC UE assistance information to the second network node as an Octet string. In some aspects, the network entity 1060 may include means for transmitting the BAT information in an SN addition request or an SN modification request. In some aspects, the network entity 1060 may include means for extracting the BAT information from the RRC UE assistance information. In some aspects, the network entity 1060 may include means for transmitting, for the second network node, the BAT information. In some aspects, the network entity 1060 may include means for forwarding the RRC UE assistance information to the second network node as an Octet string. In some aspects, the network entity 1060 may include means for transmitting the BAT information in an SN modification required message. In some aspects, the network entity 1060 may include means for receiving, from a second network node, BAT information associated with at least one QoS flow associated with an XR session of a UE. In some aspects, the network entity 1060 may include means for configuring, for the UE based on the BAT information, a secondary cell group (SCG) configuration, a master cell group (MCG) configuration, a discontinuous reception (DRX) configuration, or a configured grant (CG). In some aspects, the network entity 1060 may include means for configuring, for the UE based on the BAT information, the MCG configuration. In some aspects, the network entity 1060 may include means for configuring, for the UE based on the BAT information, the SCG configuration. In some aspects, the network entity 1060 may include means for receiving the BAT information in an SN modification required message. The network entity 1060 may further include means for performing any of the aspects described in connection with any of the flowcharts in FIGS. 6-9 and/or performed in the communication flow of FIG. 5. The means may be the component 199 of the network entity 1060 configured to perform the functions recited by the means. The means described above may be one or more of the components of the network entity 1060 configured to perform the functions recited by the means. In some aspects, the means may include one or more hardware components specifically configured to carry out the stated processes/algorithm, implemented by one or more processors configured to perform the stated processes/algorithm, stored within a computer-readable medium for implementation by one or more processors, or some combination thereof. In some aspects, the network entity 1060 may include the TX Processor 316, the RX Processor 370, and the controller/processor 376. As such, in one configuration, the means may be the TX Processor 316, the RX Processor 370, and the controller/processor 376 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a first network node, including: receiving, from a UE, a BAT report including BAT information associated with at least one QoS flow associated with an XR session; and transmitting, for a second network node, the BAT information associated with the at least one QoS flow.

Aspect 2 is the method of aspect 1, where the first network node is a MN associated with the UE and the second network node is a SN associated with the UE, where a direct SRB between the SN and the UE is not present.

Aspect 3 is the method of aspect 2, where the BAT report is included in RRC UE assistance information, and where transmitting the BAT information further includes: extracting the BAT information from the RRC UE assistance information; and transmitting, for the second network node, the BAT information.

Aspect 4 is the method of aspect 3, where the BAT information is included in an SN addition request or an SN modification request as an information element representative of the BAT information.

Aspect 5 is the method of aspect 2, where the BAT report is included in RRC UE assistance information, and where transmitting the BAT information further includes: forwarding the RRC UE assistance information to the second network node as an Octet string.

Aspect 6 is the method of aspect 5, where the Octet string is included in an SN addition request or an SN modification request as an information element representative of the RRC UE assistance information.

Aspect 7 is the method of any of aspects 2-6, where transmitting the BAT information further includes: transmitting the BAT information in an SN addition request or an SN modification request.

Aspect 8 is the method of aspect 7, where the SN addition request or the SN modification request further includes a system frame number (SFN) offset.

Aspect 9 is the method of aspect 1, where the second network node is a MN associated with the UE and the first network node is a SN associated with the UE, where a direct SRB between the SN and the UE is present.

Aspect 10 is the method of aspect 9, where the BAT report is included in RRC UE assistance information, and where transmitting the BAT information further includes extracting the BAT information from the RRC UE assistance information; and transmitting, for the second network node, the BAT information.

Aspect 11 is the method of aspect 10, where the BAT information is included in an SN modification required message as an information element representative of the BAT information.

Aspect 12 is the method of aspect 9, where the BAT report is included in RRC UE assistance information, and where transmitting the BAT information further includes: forwarding the RRC UE assistance information to the second network node as an Octet string.

Aspect 13 is the method of aspect 12, where the Octet string is included in an SN modification required message as an information element representative of the RRC UE assistance information.

Aspect 14 is the method of any of aspects 9-13, where transmitting the BAT information further includes: transmitting the BAT information in an SN modification required message.

Aspect 15 is a method for wireless communication performed by a first network node, including: receiving, from a second network node, BAT information associated with at least one QoS flow associated with an XR session of a UE; and configuring, for the UE based on the BAT information, a secondary cell group (SCG) configuration, a master cell group (MCG) configuration, a discontinuous reception (DRX) configuration, or a configured grant (CG).

Aspect 16 is the method of aspect 15, where the first network node is a MN associated with the UE and the second network node is a SN associated with the UE, where a direct SRB between the SN and the UE is present.

Aspect 17 is the method of aspect 16, further including: configuring, for the UE based on the BAT information, the MCG configuration.

Aspect 18 is the method of aspect 15, where the second network node is a MN associated with the UE and the first network node is a SN associated with the UE, where a direct SRB between the SN and the UE is not present.

Aspect 19 is the method of aspect 18, further including: configuring, for the UE based on the BAT information, the SCG configuration.

Aspect 20 is the method of any of aspects 18-19, where receiving the BAT information further includes: receiving the BAT information in an SN modification required message.

Aspect 21 is an apparatus for wireless communication at a device including at least one memory and at least one processor coupled to the at least one memory and, the at least one processor, individually or in any combination, based at least in part on information stored in the at least one memory, the at least one processor is configured to implement any of aspects 1 to 20.

Aspect 22 is the apparatus of aspect 21, further including one or more transceivers or one or more antennas coupled to the at least one processor.

Aspect 23 is an apparatus for wireless communication at a device including means for implementing any of aspects 1 to 20.

Aspect 24 is a computer-readable medium (e.g., a non-transitory computer-readable medium) storing computer executable code, where the code when executed by at least one processor causes the at least one processor to implement any of aspects 1 to 20.

What is claimed is:

1. An apparatus for wireless communication at a first network node, comprising:
at least one memory; and
at least one processor coupled to the at least one memory, and based at least in part on information stored in the at least one memory, the at least one processor is configured to:
receive, from a user equipment (UE), a burst arrival time (BAT) report comprising BAT information associated with at least one quality of service (QOS) flow associated with an extended reality (XR) session; and
transmit, for a second network node, the BAT information associated with the at least one QoS flow.

2. The apparatus of claim 1, wherein the first network node is a master node (MN) associated with the UE and the second network node is a secondary node (SN) associated with the UE, wherein a direct signaling radio bearer (SRB) between the SN and the UE is not present.

3. The apparatus of claim 2, wherein the BAT report is included in radio resource control (RRC) UE assistance information, and wherein to transmit the BAT information, the at least one processor is configured to:
extract the BAT information from the RRC UE assistance information; and
transmit, for the second network node, the BAT information.

4. The apparatus of claim 3, wherein the BAT information is included in an SN addition request or an SN modification request as an information element representative of the BAT information.

5. The apparatus of claim 2, wherein the BAT report is included in radio resource control (RRC) UE assistance information, and wherein to transmit the BAT information, the at least one processor is configured to:
forward the RRC UE assistance information to the second network node as an Octet string.

6. The apparatus of claim 5, wherein the Octet string is included in an SN addition request or an SN modification request as an information element representative of the RRC UE assistance information.

7. The apparatus of claim 2, wherein to transmit the BAT information, the at least one processor is configured to:
transmit the BAT information in an SN addition request or an SN modification request.

8. The apparatus of claim 7, wherein the SN addition request or the SN modification request further includes a system frame number (SFN) offset.

9. The apparatus of claim 1, wherein the second network node is a master node (MN) associated with the UE and the first network node is a secondary node (SN) associated with the UE, wherein a direct signaling radio bearer (SRB) between the SN and the UE is present.

10. The apparatus of claim 9, wherein the BAT report is included in radio resource control (RRC) UE assistance information, and wherein to transmit the BAT information, the at least one processor is configured to:
extract the BAT information from the RRC UE assistance information; and
transmit, for the second network node, the BAT information.

11. The apparatus of claim 10, wherein the BAT information is included in an SN modification required message as an information element representative of the BAT information.

12. The apparatus of claim 9, wherein the BAT report is included in radio resource control (RRC) UE assistance information, and wherein to transmit the BAT information, the at least one processor is configured to:
forward the RRC UE assistance information to the second network node as an Octet string.

13. The apparatus of claim 12, wherein the Octet string is included in an SN modification required message as an information element representative of the RRC UE assistance information.

14. The apparatus of claim 9, wherein to transmit the BAT information, the at least one processor is configured to:
transmit the BAT information in an SN modification required message.

15. An apparatus for wireless communication at a first network node, comprising:
at least one memory; and
at least one processor coupled to the at least one memory, and based at least in part on information stored in the at least one memory, the at least one processor is configured to:
receive, from a second network node, burst arrival time (BAT) information associated with at least one quality of service (QOS) flow associated with an extended reality (XR) session of a user equipment (UE); and
configure, for the UE based on the BAT information, a secondary cell group (SCG) configuration, a master cell group (MCG) configuration, a discontinuous reception (DRX) configuration, or a configured grant (CG).

16. The apparatus of claim 15, wherein the first network node is a master node (MN) associated with the UE and the second network node is a secondary node (SN) associated with the UE, wherein a direct signaling radio bearer (SRB) between the SN and the UE is present.

17. The apparatus of claim 16, wherein the at least one processor is configured to:
configure, for the UE based on the BAT information, the MCG configuration.

18. The apparatus of claim 15, wherein the second network node is a master node (MN) associated with the UE and the first network node is a secondary node (SN) associated with the UE, wherein a direct signaling radio bearer (SRB) between the SN and the UE is not present.

19. The apparatus of claim 18, wherein the at least one processor is configured to:
configure, for the UE based on the BAT information, the SCG configuration.

20. The apparatus of claim 18, wherein to receive the BAT information, the at least one processor is configured to:
receive the BAT information in an SN modification required message.
